(19) United States
(12) Patent Application Publication
(10) Pub. No.: US 2025/0329942 A1
(43) Pub. Date: Oct. 23, 2025

(54) ELECTRICAL CONNECTOR HAVING A WIRE CABLE WELDED DIRECTLY TO A TERMINAL

(71) Applicant: Aptiv Technologies AG, Schaffhausen (CH)

(72) Inventors: John MORELLO, Warren, OH (US); James Rainey, Warren, OH (US); Steven Ragalyi, Cortland, OH (US)

(21) Appl. No.: 18/643,295

(22) Filed: Apr. 23, 2024

(51) Int. Cl. H01R 4/02; H01R 13/50; H01R 13/6581; H01R 13/6593

(52) U.S. Cl. CPC H01R 4/023; H01R 13/50; H01R 13/6581; H01R 13/6593

(57) ABSTRACT

An electrical connector assembly may include a wire cable having an elongate conductor extending along a longitudinal axis. The conductor defines an exposed face arranged substantially perpendicular to the longitudinal axis. The exposed face has a surface area that is substantially equal to a cross sectional area of the conductor. The electrical connector assembly may also include an electrical terminal having a contact face. The exposed face of the conductor is metallurgically welded to the contact face of the electrical terminal. A method of assembling an electrical connector is also provided.

### TECHNICAL FIELD

This invention is directed to an electrical connector, particularly to an electrical connector having a wire cable that is welded directly to a terminal.

### BACKGROUND

Electrical connectors, particularly those used with a wire cable having a small cross section, e.g., less than 2 mm², are typically attached to the wire cable using a crimping process. Crimping terminals to the wire becomes more difficult as the cross section decreases. For example, the inner terminals of miniature coaxial connectors are typically crimped to the center conductor of the coaxal cable which has a cross section of 0.2 to 0.3 mm² and then inserted into a shielding outer terminal assembly. Variations in crimping effectiveness due to the small cross section of the center conductor may cause issues with radio frequency (RF) performance of the connector and/or may cause issues with retention of the inner terminal to the coaxial cable. In a right angled miniature coaxial connector, the electrical terminal attached to the center conductor typically interfaces with a second terminal arranged at a right angle to the first terminal. This interface between the two terminal increases the size required for the coaxial connector, may cause signal loss, and may reduce RF performance of the connector. Therefore, an electrical connector that addresses these problems remains desired.

### SUMMARY

In some aspects, the techniques described herein relate to an electrical connector assembly, including: a wire cable having an elongate conductor extending along a longitudinal axis, wherein the elongate conductor defines an exposed face arranged substantially perpendicular to the longitudinal axis and wherein the exposed face has a surface area that is substantially equal to a cross sectional area of the elongate conductor; and an electrical terminal having a contact face metallurgically welded to the exposed face of the elongate conductor.

In some aspects, the techniques described herein relate to a method of assembling an electrical connector, including: providing a wire cable having an elongate conductor extending along a longitudinal axis, wherein the elongate conductor defines an exposed face arranged substantially perpendicular to the longitudinal axis and having a surface area substantially equal to a cross sectional area of the elongate conductor; providing an electrical terminal having a contact face; placing a first welding probe in intimate mechanical and electrical contact with the elongate conductor and placing a second welding probe in intimate mechanical and electrical contact with the electrical terminal; placing the exposed face of the elongate conductor in intimate mechanical and electrical contact with the electrical terminal; and applying electrical power as a voltage across the first and second welding probes, thereby forming a welded metallurgical bond between the elongate conductor and the electrical terminal.

### BRIEF DESCRIPTION OF THE DRAWINGS

Embodiments of the present invention will now be described by way of example with reference to the accompanying drawings, in which:

FIG. 1 shows an isometric view of a right angled coaxial electrical connector and coaxial cable according to a first embodiment.

FIG. 2 shows an exploded view of a right angled coaxial electrical connector and coaxial cable with a stripped center conductor according to the first embodiment.

FIG. 3 shows a cross-section view of the right angled coaxial electrical connector and coaxial cable of FIG. 1 according to the first embodiment.

FIG. 4 shows an isometric view of the right angled coaxial electrical connector of FIG. 1 and a pair of welding probes according to a first embodiment.

FIG. 5 shows a cross-section view of the right angled coaxial electrical connector and coaxial cable of FIG. 1 with the welding probes of FIG. 4 in place prior to welding the center conductor to a terminal of the connector according to the first embodiment.

FIG. 6 shows a cross-section view of the right angled coaxial electrical connector and coaxial cable of FIG. 1 with the welding probes of FIG. 4 in place after welding the center conductor to the electrical terminal according to the first embodiment.

FIG. 7 shows a cross-section view of the right angled coaxial electrical connector and coaxial cable with the welding probes in place prior to and after welding a center conductor of the coaxial cable to a terminal of the connector according to a second embodiment.

FIG. 8 shows a side view of a right angled coaxial electrical connector and coaxial cable with an unstripped center conductor according to a third embodiment.

FIG. 9A shows a cross-section view of the right angled coaxial electrical connector of FIG. 8 with the unstripped center conductor contacting a terminal in the connector according to a third embodiment.

FIG. 9B shows a close-up cross-section view of the unstripped center conductor contacting the electrical terminal in in FIG. 9A according to a third embodiment.

FIG. 10 shows an isometric view of a right angled coaxial electrical connector and coaxial cable with an unstripped center conductor with accessible welding contact areas according to a fourth embodiment.

FIG. 11 shows a cross section view of the right angled coaxial electrical connector and coaxial cable of FIG. 10 with the unstripped center conductor contacting a terminal in the connector prior to welding the center conductor to the electrical terminal according to a fourth embodiment.

FIG. 12 shows an isometric view of the of a right angled coaxial electrical connector and coaxial cable of FIG. 10 with the welding contact areas enclosed by an outer terminal according to a fourth embodiment.

FIG. 13 shows a cross section view of the right angled coaxial electrical connector and coaxial cable of FIG. 10 with the unstripped center conductor contacting a terminal in the connector according after welding the center conductor to the electrical terminal with the welding contact areas enclosed by an outer terminal according to a fourth embodiment.

FIG. 14 shows a cross-section view of a right angled coaxial electrical connector and a stripped coaxial cable with welding probes aligned with welding contact areas prior to welding the center conductor to a terminal of the connector according to a fifth embodiment.

FIG. 15 shows a cross-section view of the right angled coaxial electrical connector and the stripped coaxial cable of FIG. 14 with the welding probes in place after welding the center conductor to a terminal of the connector according to the fifth embodiment.

FIG. 16A shows a cross-section view of a right angled coaxial electrical connector and a stripped coaxial cable in a pre-welded configuration according to a sixth embodiment.

FIG. 16B shows a cross-section view of a right angled coaxial electrical connector and a stripped coaxial cable in a post-welded configuration according to the sixth embodiment.

FIG. 17 shows an isometric view of a straight coaxial electrical connector according to a seventh embodiment.

FIG. 18 shows a cross section view of the straight coaxial electrical connector of FIG. 17 according to the seventh embodiment.

FIG. 19 shows a cross section view of an electrical connector according to an eighth embodiment.

FIG. 20 shows a flow chart of a method of assembling an electrical connector according to some embodiments.

### DETAILED DESCRIPTION

This disclosure presents an electrical connector having a wire cable welded directly to a terminal, several examples of which are described in the figures of the drawing and the following written description. Also presented herein is a method of welding electrical conductors in a wire cable directly to a terminal in an electrical connector, thereby eliminating the need for crimping the electrical terminal to the conductor. This provides several benefits, such as decreased electrical resistance in the bond between the conductor and terminal, improved mechanical retention of the conductor to the electrical terminal, and decreased terminal size due to the elimination of the crimping wing. Other benefits may be realized, several of which will be discussed later.

The electrical terminal and conductor may be welded using an electrical resistance welding process. A first welding probe may be placed in contact with the connector and a second welding probe may be placed in contact with the electrical terminal. An electrical voltage is applied between the first and second welding probes, causing an electrical current following therethrough to heat and melt an interface between the conductor and terminal, thereby welding them together. The inventors have found that percussion resistance welding is particularly useful in this application. Using a percussion welding technique, the electrical terminal and the conductor are spaced apart. The electrical voltage is then applied to the first and second welding probes while the electrical terminal and the conductor are spaced apart. The energized terminal and the conductor are then brought into proximity with each other, thereby generating an arc between the conductor and terminal and causing material in both to melt. The electrical voltage is removed from the first and second welding probes and the conductor and terminal are then thrust together while still molten, thereby forming a mechanical and electrical bond between them. This percussion welding process requires only milliseconds and therefore does not generate enough heat to damage a connector housing formed of polymeric insulating materials in which the electrical terminal and conductor are disposed.

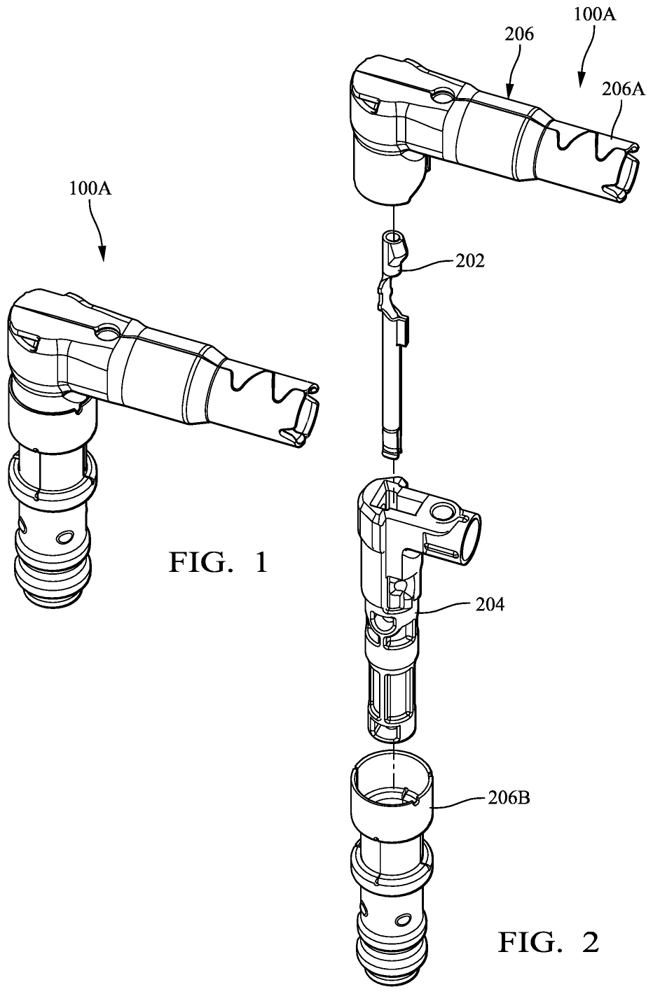

A first example of an electrical connector embodying the features is shown in FIGS. 1 to 6. FIG. 1 illustrates an isometric view of an exemplary right angled coaxial connector, hereafter referred to as the connector 100A.

As shown in the exploded view of FIG. 2, the connector 100A includes a conductive central terminal, hereafter referred to as the central terminal 202, that is disposed within an insulative terminal housing, hereafter referred to as the housing 204. The housing 204 is typically formed of an electrically insulative polymeric material, such as polyamide (NYLON) or polybutylene terephthalate (PBT). The central terminal 202 and housing 204 are themselves disposed within an outer shield terminal 206 that is formed of an electrically conductive material, such as tin-plated brass sheet metal. The outer shield terminal 206 may be formed of multiple parts 206A, 206B as illustrated here or integrally formed, e.g., from a metal billet.

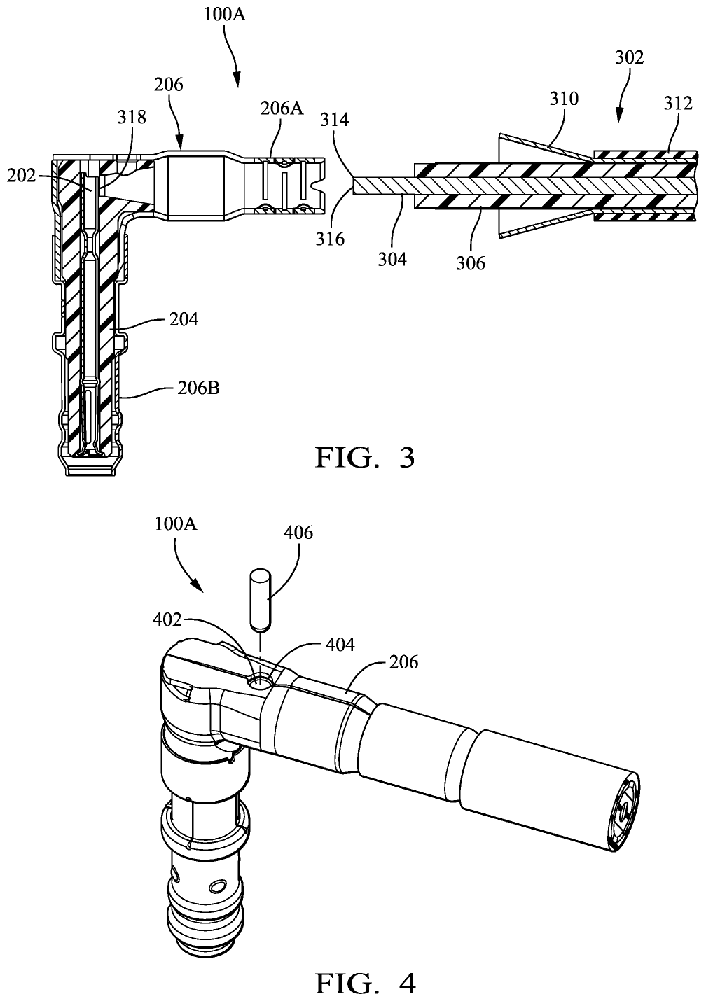

FIG. 3 shows a cross section view of the connector 100A and a coaxial wire cable 302. The connector 100A is configured to terminate the coaxial wire cable 302, which includes a central conductor 304, an inner insulator 306 surrounding the central conductor 304, a shield conductor 310 surrounding the inner insulator 306, and an outer insulative jacket 312 surrounding the shield conductor 310. The central terminal 202 is configured to terminate the central conductor 304 and the outer shield terminal 206 is configured to terminate the shield conductor 310. A portion of the inner insulator 306 is removed, thereby exposing the central conductor 304. An end of the exposed portion 314 of the central conductor 304 defines an exposed face 316 that is arranged substantially perpendicular to a longitudinal axis X of the central conductor 304. This causes the exposed face 316 of the central conductor 304 to have a surface area that is substantially equal to a cross sectional area of the central conductor 304. The central terminal 202 has a contact face 318 on a side of the central terminal 202.

FIG. 4 is a top isometric view of the connector 100A that shows an access portal 402 in the housing 204 and an access aperture 404 in the outer shield terminal 206. The access portal 402 and access aperture 404 are aligned to provide access through which a first welding probe 406 contacts the central conductor 304.

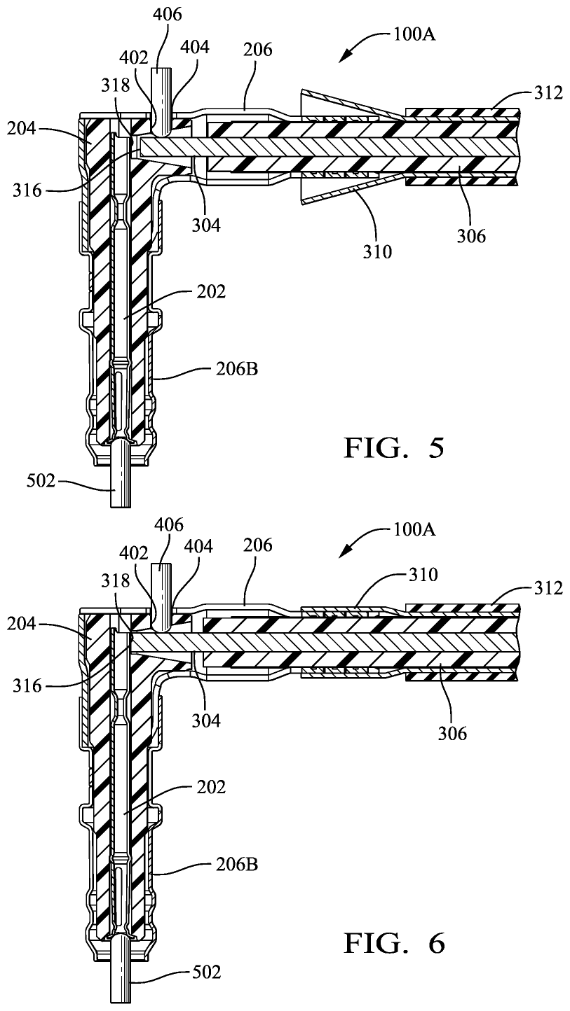

FIG. 5 is another cross section view of the connector 100A in which the coaxial wire cable 302 is inserted within the connector 100A. The first welding probe 406 is inserted through the access portal 402 and the access aperture 404 so that it contacts the central conductor 304. A second welding probe 502 is inserted through an opening in the shield terminal 206 and is in contact with the central terminal 202. The exposed face 316 of the central conductor 304 is spaced apart from the contact face 318 of the central terminal 202. While in this condition, the first welding probe 406 and the second welding probe 502 are connected to an electrical power supply (not shown) and a voltage sufficient to create an electrical arc between the exposed face 316 and the contact face 318 is applied across the first and second welding probes 406, 502 and melting a small portion of the material forming the exposed face 316 and the contact face 318.

FIG. 6 is yet another cross section view of the connector 100A in which the voltage is removed from the first and second welding probes 406, 502 and the molten material of the exposed face 316 is immediately brought into contact with the molten material of the contact face 318, thereby welding the central conductor 304 to the central terminal 202.

The first and second welding probes 406, 502 may remain in contact with the central terminal 202 and the central conductor 304 the voltage is removed, or they may be withdrawn from contact.

The shield conductor 310 is held in contact with the outer shield terminal 206A by an outer ferrule (not shown) crimped over the shied conductor 310 and the outer shield terminal 206A.

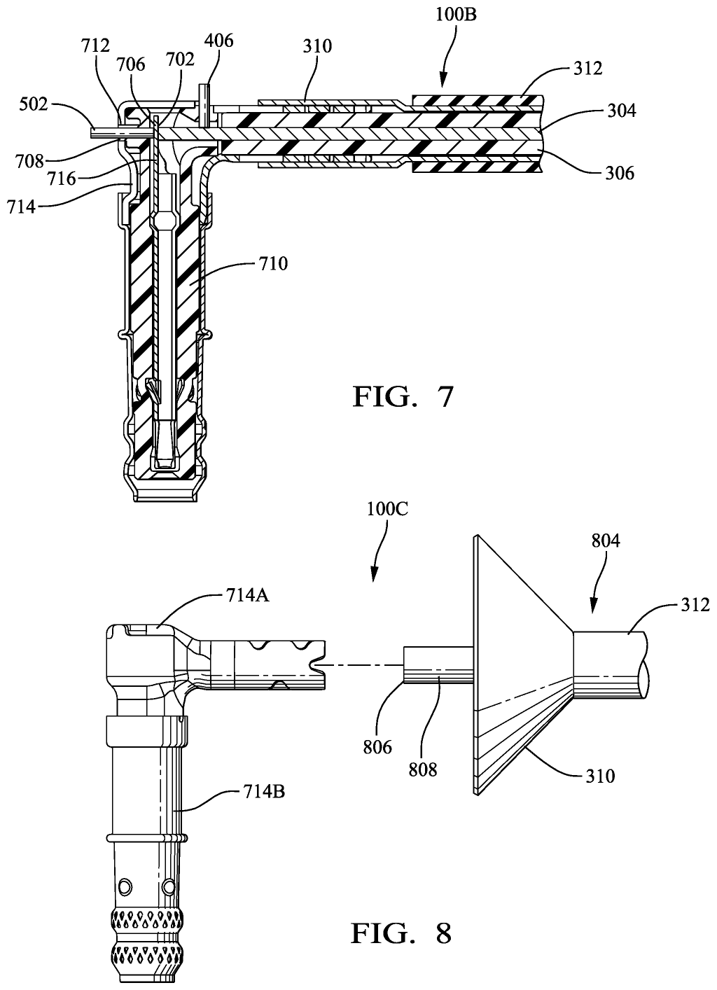

A second example of an electrical connector, hereafter referred to as connector 100B, is shown in FIG. 7. Connector 100B is visually and functionally similar to connector 100A. Connector 100B differs from connector 100A in that a contact face 702 of the central terminal 704 is defined by a tab 706 extending from the central terminal 704 rather than the contact face 318 being defined by a side of the central terminal 202. In addition, the connector 100B includes a second access portal 708 in the housing 710 and a second access aperture 712 in the shield terminal 714A, 714B that provides the second welding probe 502 access to a surface 716 of the tab 706 located opposite the contact face 702. The process for welding the central conductor 304 to the central terminal 202 of connector 100A may also be generally applied to connector 100B. In some embodiments, the proximal location of the second welding probe 502 relative to the contact face 318 provides a benefit of reducing resistive losses and heating in the central terminal 704 during the welding process. In some embodiments, the tab 706 provides a flatter contact face 702 than the contact face 318 of connector 100A, which may present a cylindrical surface to exposed face 316.

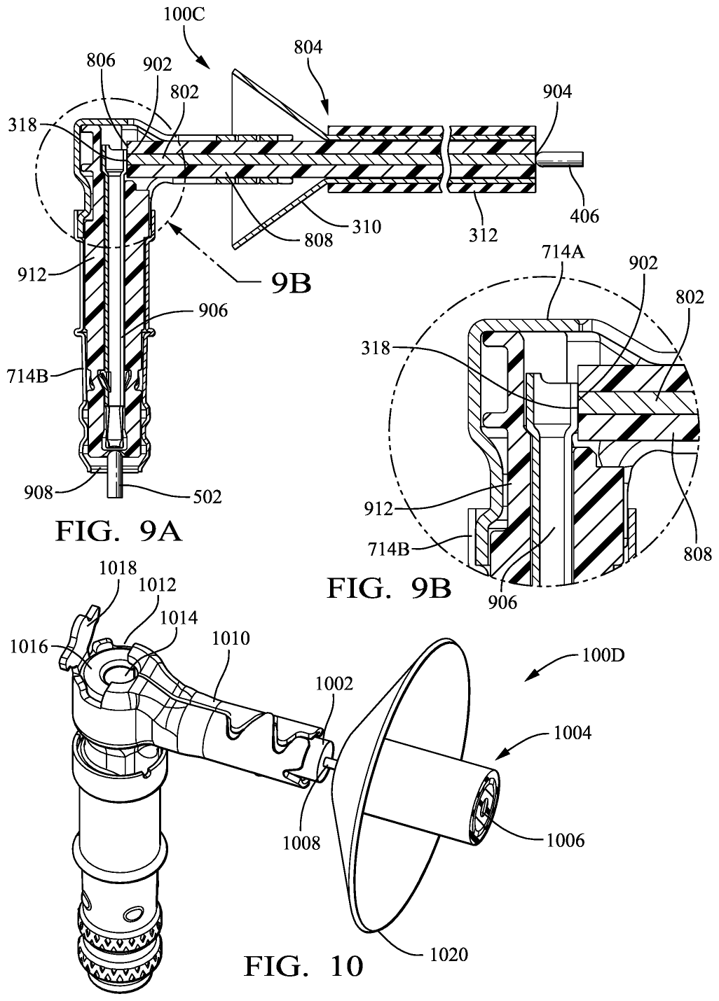

A third example of an electrical connector, hereafter referred to as connector 100C, is shown in FIGS. 8, 9A and 9B. Connector 100C is also visually and functionally similar to connectors 100A and 100B. However, rather than the coaxial wire cable 302 having an exposed portion of the central conductor 304 extending beyond the inner insulator 306 as used with connectors 100A and 100B, A central conductor 802 of the coaxial wire cable 804 is flush with a blunt end 806 of the inner insulator 808 as shown in FIG. 8.

FIG. 9A is a cross section view of connector 100C. As can be seen in this figure, the exposed face 902 of the central conductor 802 is also flush with the blunt end 806 of the inner insulator 808. The first welding probe 406 is in contact with an end 904 of the central conductor 802 opposite the exposed face 902. The second welding probe 502 is in contact with the central terminal 906 though an opening 908 in the shield terminal 714B similarly to connector 100A. The process for welding the central conductor 802 to the central terminal 906 of connector 100A may also be generally applied to connector 100C.

As seen in FIG. 9A, connector 100C does not include an access portal in the housing 912 or an access aperture in the shield terminal 910 since the central conductor 802 may not be contacted by the first welding probe 406 when the coaxial wire cable 804 inside connector 100C. Connector 100C provides the benefit of eliminating the need to strip the end of the coaxial cable 804 and may have a smaller size than connectors 100A and 100B.

FIG. 9B shows a close up cross section view of the interface between the central conductor 802 and the central terminal 906 of connector 100C.

A third example of an electrical connector, hereafter referred to as connector 100D, is shown in FIG. 10. Connector 100D is also visually and functionally similar to connector 100C. Connector 100D differs from connector 100C in that, a portion of the inner insulator 1002 of the coaxial wire cable 1004 is removed or otherwise displaced from the central conductor 1006 in a location that is spaced apart from an end of the coaxial wire cable 1004, thereby forming an exposed portion 1008 of the central conductor 1006. The inner insulator 1002 may be permanently displaced by removing the portion of the inner insulation shown in FIG. 10 or the inner insulator 1002 may be temporarily displaced by piercing the inner insulation, e.g., with a pointed or bladed object. The shield terminal 1010 defines an access aperture 1012 that is aligned with an access portal 1014 in the housing 1016. The shield terminal 1010 further defines a tab 1018 that is configured to be bent over to close off the access aperture 1012.

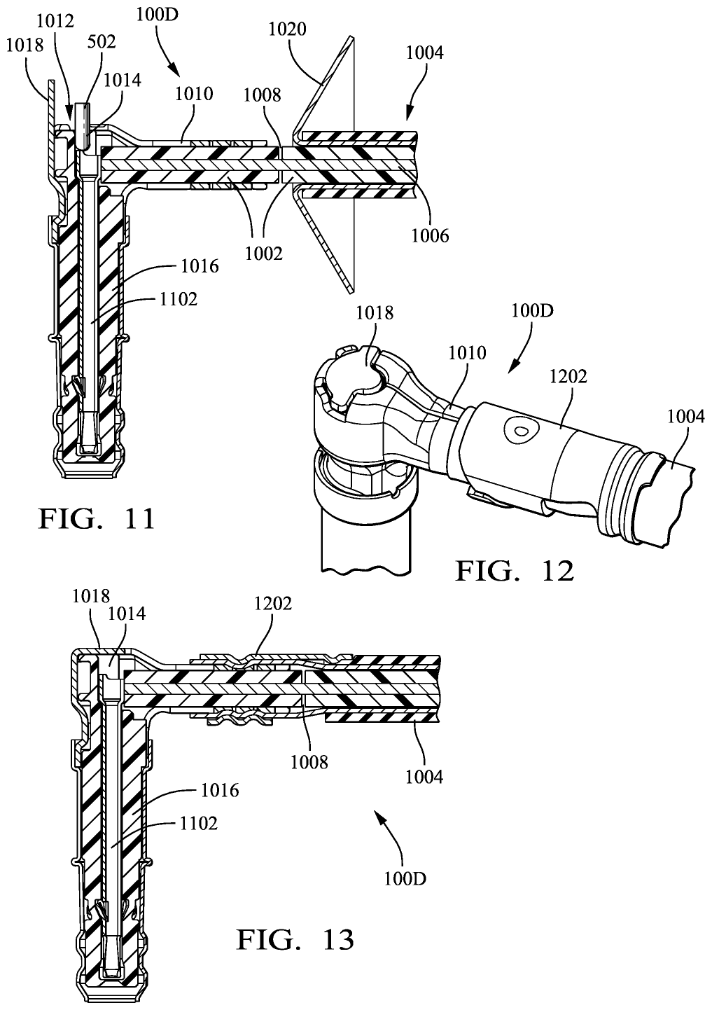

FIG. 11 shows a cross section view of connector 100D. The first welding probe (not shown) is brought into contact with this exposed portion 1008 of the central conductor 1006. The second welding probe 502 contacts the central terminal 1102 though the access aperture 1012 and the access portal 1014. The process for welding the central conductor 304 to the central terminal 202 of connector 100A may also be generally applied to connector 100D.

As shown in FIG. 12, after welding the central conductor 1006 to the central terminal 202, the first and second welding probes 406, 502 are withdrawn, the tab 1018 is bent over to close the access aperture 1012 and enclose the access portal 1014. The shield conductor 1020 is then folded back over the shield terminal 1010. An outer ferrule 1202 is attached to the shield terminal 1010 and the shield conductor 1020 is captured between the outer ferrule 1202 and shield terminal 1010 as the outer ferrule 1202 is crimped to the shield terminal 1010, thereby enclosing the exposed portion 1008 of the central conductor 1006 as shown in the cross section view of FIG. 13 As further shown in FIG. 13, the closed tab 1018 enclosing the access portal 1014 and the outer ferrule 1202 attached to the shield terminal 1010 and enclosing the exposed portion 1008 of the central conductor 1006.

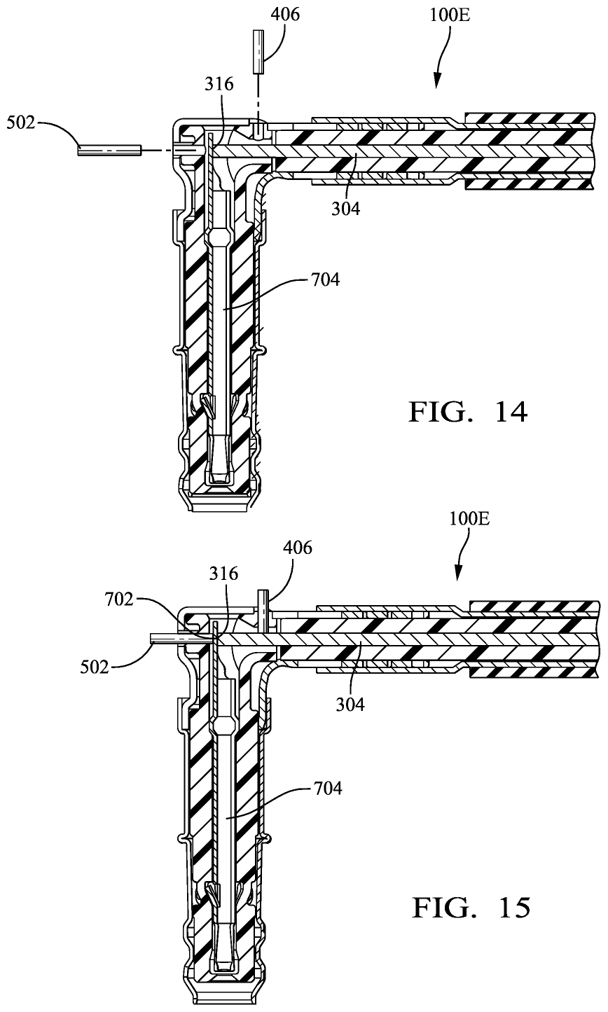

A fifth example of an electrical connector, hereafter referred to as connector 100E, is shown in FIG. 14. Connector 100E is visually and functionally similar to connector 100B. However, in contrast to connector 100B, the exposed face 316 of the central conductor 304 is brought into contact with the contact face 702 of the central terminal 704 prior to the first and second welding probes 406, 502 being brought into contact with the central terminal 704 and the central conductor 304 as shown in FIG. 14. The central terminal 704 is welded to the central conductor 304 using a conventional resistance welding process rather than a percussive welding process when the first and second welding probes 406, 502 are in contact with the central terminal 704 and the central conductor 304 as shown in FIG. 15.

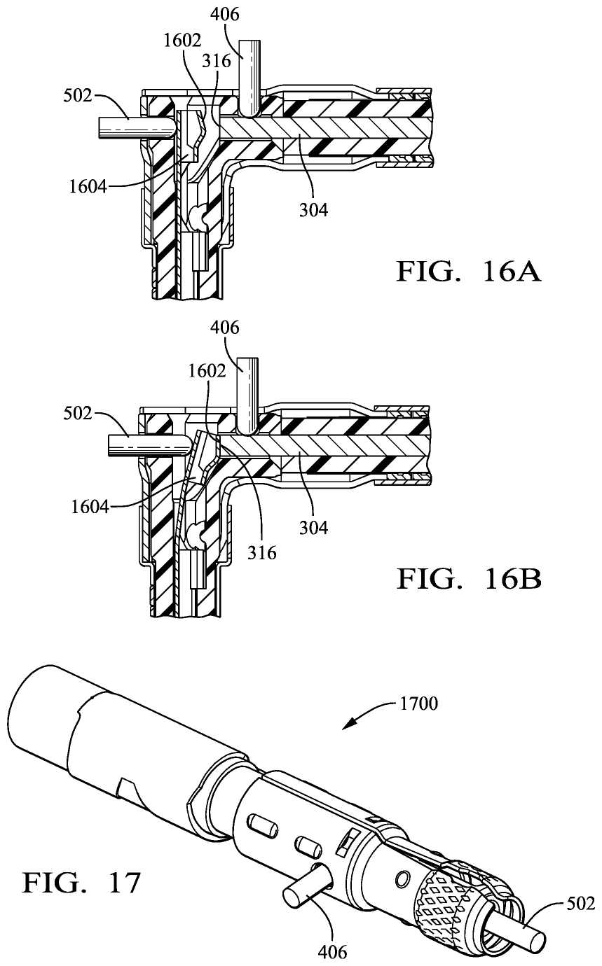

A sixth example of an electrical connector, hereafter referred to as connector 100F, is shown in FIGS. 16A and 16B. Connector 100F is visually and functionally similar to connector 100B. However, in contrast to connector 100B, contact face 1602 of the central terminal 1604 is bent toward the exposed face 316 of the central conductor 304 until brought into contact with the exposed face 316. The contact face 1602 of the central terminal 1604 may be bent by the second welding probe 502 or may be bent by some other device. If the second welding probe 502 is used to bend the contact face 1602 of the central terminal 1604, the second welding probe 502 may or may not be energized as contact face 702 of the central terminal 704 is bent toward the exposed face 316 of the central conductor 304. The central conductor 304 may be welded to the central terminal 704 by using a percussive welding process or a conventional resistance welding process.

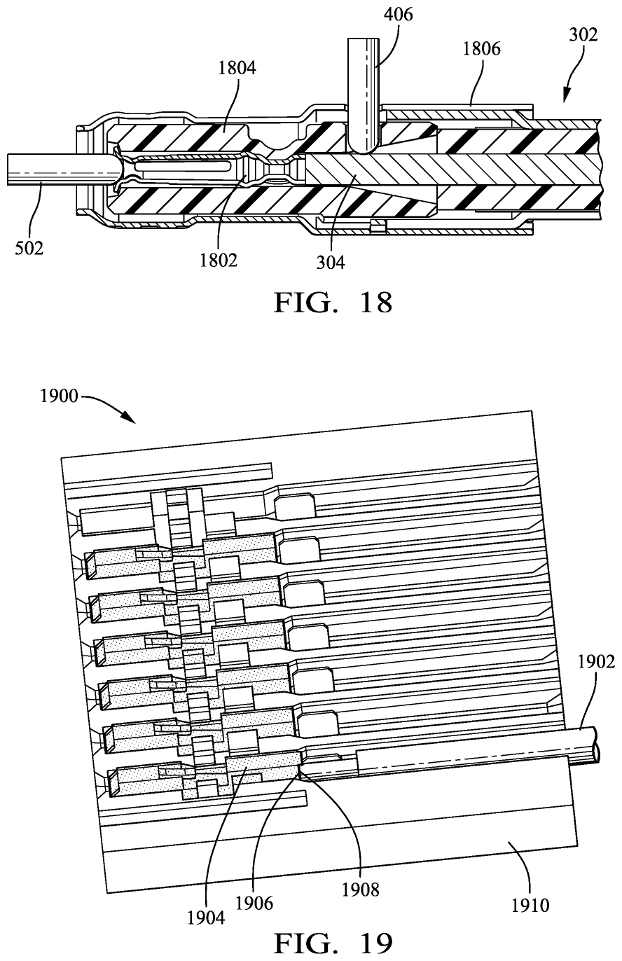

A seventh example of an electrical connector, hereafter referred to as connector 1700, is shown in FIG. 17. Connector 1700 is functionally similar to connector 100A, except that connector 1700 is a straight coaxial connector rather than a right angled connector. FIG. 18 shows a cross section view of connector 1700 which illustrates a central terminal 1802 connected to the central conductor 304 of the coaxial cable 302 by one of the welding processes described above. The central terminal 1802 is disposed within an insulation housing 1804 which is itself disposed within a shield terminal 1806 connected to the shield conductor 310.

An eighth example of an electrical connector, hereafter referred to as connector 1900 is shown in FIG. 19. Rather than being a coaxial electrical connector like connectors 100A-100F and 1700, connector 1900 is configured to connect a plurality of single conductor or stranded multiple conductor wire cables 1902 to a plurality of terminals 1904 each having a contact face 1906 by welding the contact faces 1906 directly to exposed faces 1908 of the wire cables 1902 using a percussive welding or resistance welding technique as described above. The contact faces of the electrical terminals are arranged in an insulative housing 1910 so that they are generally perpendicular to the exposed faces 1908 of the wire cables 1902. Ends of the wire cables 1902 may be stripped of insulation prior to welding as shown in FIG. 19 or the exposed ends may be flush with a blunt end of the insulation of the cables, similar to that shown in FIGS. 8, 9A, and 9B. The electrical terminals 1904 may be preloaded into the insulative housing 1910 prior to attachment to the wire cables 1902. The insulative housing 1910 of FIG. 19 defines snap features 1912 that allow the electrical terminals 1904 to be loaded into the insulative housing 1910 laterally, i.e. perpendicularly to the longitudinal axis of the wire cables 1902, rather than longitudinally, i.e. parallel to the longitudinal axis of the wire cables 1902, as is typically required with conventional connector housings.

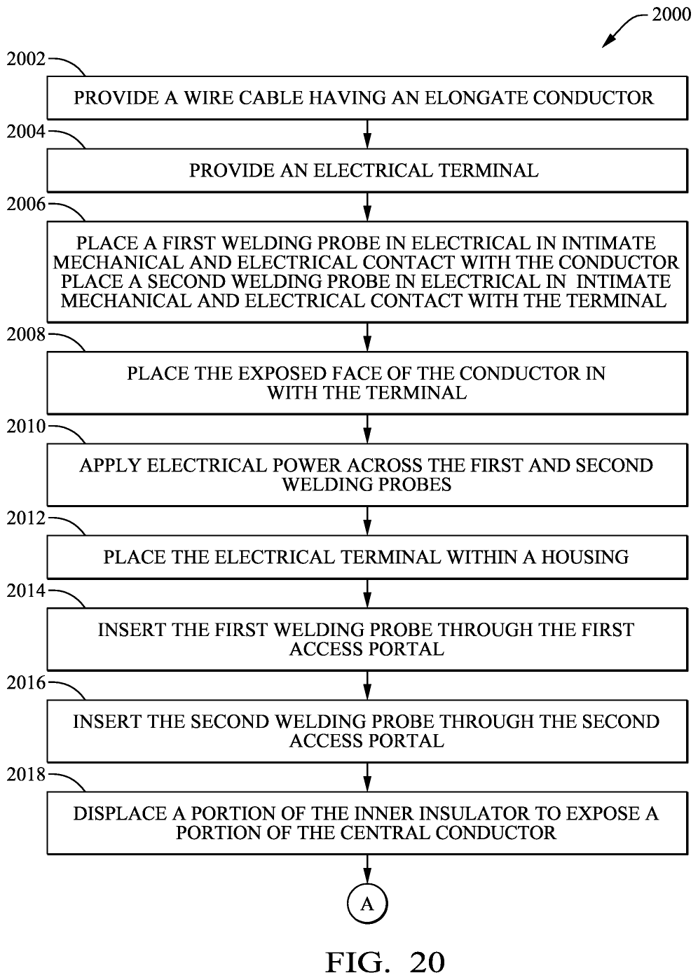

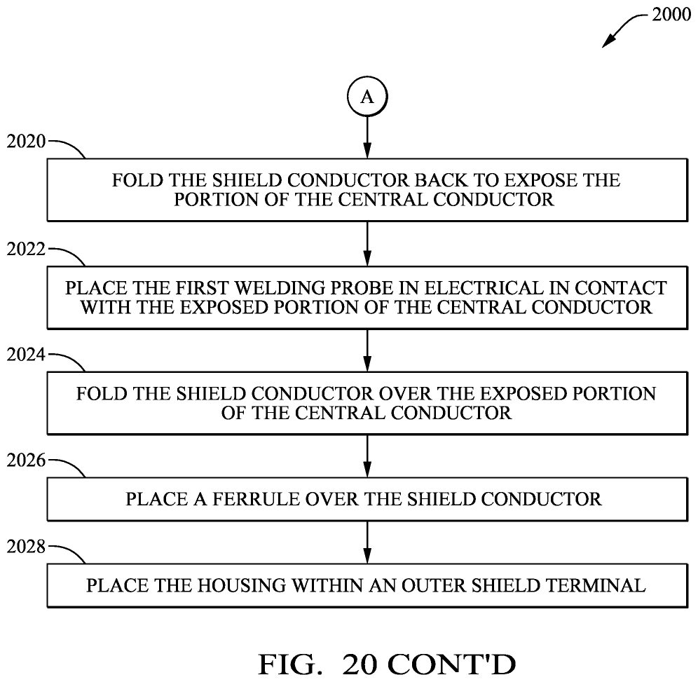

FIG. 20 shows a flow chart of a method 2000 for assembling an electrical connector that may be employed to manufacture any of the electrical connectors (100A-G) described above. The method 2000 includes the steps of:

At STEP 2002, a wire cable having an elongate conductor is provided. In some embodiments STEP 2002 includes providing a wire cable 302 having an elongate conductor 304 extending along a longitudinal axis X. The conductor 304 defines an exposed face 316 arranged substantially perpendicular to the longitudinal axis X and has a surface area that is substantially equal to a cross sectional area of the conductor 304.

AT STEP 2004, an electrical terminal is provided. In some embodiments, STEP 2004 includes providing an electrical terminal 202 having a contact face 318.

At STEP 2006, a first welding probe is placed in contact with the conductor and a second welding probe is placed in contact with the electrical terminal. In some embodiments, STEP 2006 includes placing a first welding probe 406 in intimate mechanical and electrical contact with the conductor 304 and placing a second welding probe 502 in intimate mechanical and electrical contact with the electrical terminal 202.

At STEP 2008, electrical power is applied to the first and second welding probes. In some embodiments, STEP 2008 includes applying electrical power as a voltage across the first and second welding probes 406, 502, thereby forming a welded metallurgical bond between the conductor 304 and the electrical terminal 202.

At STEP 2010, the electrical terminal is placed within a housing. In some embodiments, STEP 2010 includes placing the electrical terminal 202 within an electrically insulative housing 204. The housing 204 may define a first access portal 402 that is configured to allow the first welding probe 406 to be in intimate mechanical and electrical contact with the conductor 304. The housing 710 may additionally or alternatively define a second access portal 708 that is configured to allow the second welding probe 502 to be in intimate mechanical and electrical contact with the conductor 304.

At STEP 2012, the first welding probe is inserted through the first access portal. In some embodiments, STEP 2012 includes extending the first welding probe 406 through the first access portal 402 such that it is in intimate mechanical and electrical contact with the conductor 304.

At STEP 2014, the second welding probe is inserted through the second access portal. In some embodiments, STEP 2014 includes extending the second welding probe 502 through the second access portal 708 such that it is in intimate mechanical and electrical contact with the electrical terminal 704. In some embodiments the second access portal 708 is defined by the housing 710. In other embodiments, the second access portal is defined by an opening in an end of the shield terminal 206B that allows access to the central terminal 202 (see FIG. 5).

At STEP 2016, the first welding probe is placed in intimate mechanical and electrical contact with the exposed portion of the central conductor. In some embodiments, STEP 2016 includes placing the first welding probe 406 in intimate mechanical and electrical contact with the exposed portion 1008 of the central conductor 1006.

AT STEP 2018, the housing is placed within an outer shield terminal. In some embodiments, STEP 2018 includes; placing the housing 204 within an outer shield terminal 206. The outer shield terminal 206 defines an access aperture 404 that is arranged coaxially with the access portal 402 of the housing 204. In some embodiments, the outer shielding terminal 1010 defines a tab 1018 located proximate the access aperture 1012 that is configured to be bent over to enclose the access aperture 1012 and the access portal 402.

In some embodiments the voltage is applied across the first and second welding probes 406, 502 before the exposed face 316 of the conductor 304 is placed in intimate mechanical and electrical contact with the electrical terminal 202 as shown in FIG. 5.

In some embodiments, the voltage is applied across the first and second welding probes 406, 502 after the exposed face 316 of the conductor 304 is placed in intimate mechanical and electrical contact with the electrical terminal 202 as shown in FIG. 6.

In some embodiments, the conductor 304 is spaced apart from the electrical terminal 202 when the voltage is applied across the first and second welding probes 406, 502 as shown in FIG. 5. The exposed face 316 of the conductor 304 is then moved into proximity with the contact face 318 of the electrical terminal 202 after the voltage is applied across the first and second welding probes 406, 502, thereby creating an arc between the exposed face 316 and the contact face 318 and melting a portion of the material of the exposed face 316 and the contact face 518. The exposed face 316 and the contact face 318 are then brought into intimate mechanical contact as shown in FIG. 6, thereby welding the exposed face 316 to the contact face 318.

In some embodiments, the wire cable 302 is a coaxial wire cable 302. The conductor 304 is a central conductor 304 surrounded by an inner insulator 306. The inner insulator 306 is surrounded by a shield conductor 310. In some embodiments, the central conductor 304 extends beyond the inner insulator 306 as shown in FIG. 5. In some embodiments, the exposed face 902 is flush with a blunt end 806 of the inner insulator 808 as shown in FIG. 9A.

In some embodiments, a portion of the inner insulator is displaced to expose a portion of the central conductor as shown in FIG. 11. This includes displacing a portion of the inner insulator 1002 to expose a portion of the central conductor 1006. The exposed portion 1008 of the inner insulator 1002 is spaced apart from the exposed face 902.

In some embodiments, the shield conductor is folded back to expose the portion of the central conductor. This includes folding the shield conductor 1020 back to expose the portion 1008 of the central conductor 1006 as shown in FIG. 11, thereby providing access for the first welding probe 406 to be in intimate mechanical and electrical contact with the central conductor 1006.

In some embodiments, the shield conductor is folded over the exposed portion of the central conductor after applying the voltage across the first and second welding probes. This includes folding the shield conductor 1020 over the exposed portion 1008 of the central conductor 1006 as shown in FIG. 13 after applying the voltage across the first and second welding probes 406, 502.

In some embodiments, a ferrule is placed over the shield conductor. This includes placing an outer ferrule 1202 over the shield conductor 1020 as shown in FIG. 13, thereby enclosing the exposed portion 1008 of the central conductor 1006.

In some embodiments, the electrical terminal 704 is spaced apart from the conductor 304 when the voltage is applied across the first and second welding probes 406, 502 as shown in FIG. 16A. A tab 706 of the electrical terminal 704 is then bent to move the contact face 702 of the electrical terminal 704 into intimate mechanical and electrical contact with the exposed face 316 of the conductor 304 as shown in FIG. 16B. The voltage may be applied across the first and second welding probes 406, 502 before the tabs 706 is bent or after the contact face 702 of the electrical terminal 704 contacts the exposed face 316 of the conductor 304.

### Discussion of Possible Embodiments

The following are non-exclusive descriptions of possible embodiments of the present invention.

In some aspects, the techniques described herein relate to an electrical connector assembly, including: a wire cable having an elongate conductor extending along a longitudinal axis, wherein the elongate conductor defines an exposed face arranged substantially perpendicular to the longitudinal axis and wherein the exposed face has a surface area that is substantially equal to a cross sectional area of the elongate conductor; and an electrical terminal having a contact face metallurgically welded to the exposed face of the elongate conductor.

The assembly of the preceding paragraph can optionally include, additionally and/or alternatively any, one or more of the following features, configurations and/or additional components.

In some aspects, the techniques described herein relate to an electrical connector assembly, further including an electrically insulative housing in which the electrical terminal is disposed, wherein the housing defines an access portal configured to allow a welding probe to be in intimate mechanical and electrical contact with the conductor.

In some aspects, the techniques described herein relate to an electrical connector assembly, wherein the access portal is located and arranged in the housing such that the welding probe may be in intimate mechanical and electrical contact with the conductor both when the exposed face is spaced apart from the contact face and when the exposed face is in intimate contact with the contact face.

In some aspects, the techniques described herein relate to an electrical connector assembly, further including an outer shielding terminal in which the housing is disposed, wherein the outer shielding terminal defines an access aperture that is arranged coaxially with the access portal of the housing and wherein the access aperture has a first diameter larger than a second diameter of the access portal.

In some aspects, the techniques described herein relate to an electrical connector assembly, wherein the outer shielding terminal defines a tab which is configured to be bent into the access aperture, thereby enclosing the access portal.

In some aspects, the techniques described herein relate to an electrical connector assembly, wherein the wire cable is a coaxial wire cable, wherein the conductor is a central conductor of the coaxial wire cable and is surrounded by an inner insulator, wherein the inner insulator is surrounded by a shield conductor, and wherein the central conductor extends beyond the inner insulator.

In some aspects, the techniques described herein relate to an electrical connector assembly, wherein the wire cable is a coaxial wire cable, wherein the conductor is a central conductor of the coaxial wire cable and is surrounded by an inner insulator, wherein the inner insulator is surrounded by a shield conductor, and wherein the exposed face is flush with an end of the inner insulator.

In some aspects, the techniques described herein relate to an electrical connector assembly, wherein a portion of the central conductor that is spaced apart from the exposed face is exposed due to removal of a portion of the inner insulator, thereby providing access for a welding probe to be in intimate mechanical and electrical contact with the central conductor.

In some aspects, the techniques described herein relate to a method of assembling an electrical connector, including: providing a wire cable having an elongate conductor extending along a longitudinal axis, wherein the elongate conductor defines an exposed face arranged substantially perpendicular to the longitudinal axis and having a surface area substantially equal to a cross sectional area of the elongate conductor; providing an electrical terminal having a contact face; placing a first welding probe in intimate mechanical and electrical contact with the elongate conductor and placing a second welding probe in intimate mechanical and electrical contact with the electrical terminal; placing the exposed face of the elongate conductor in intimate mechanical and electrical contact with the electrical terminal; and applying electrical power as a voltage across the first and second welding probes, thereby forming a welded metallurgical bond between the elongate conductor and the electrical terminal.

The method of the preceding paragraph can optionally include, additionally and/or alternatively any, one or more of the following features, configurations and/or additional components.

In some aspects, the techniques described herein relate to a method, wherein the voltage is applied across the first and second welding probes after the exposed face of the conductor is placed in intimate mechanical and electrical contact with the electrical terminal.

In some aspects, the techniques described herein relate to a method, wherein the voltage is applied across the first and second welding probes before the exposed face of the conductor is placed in intimate mechanical and electrical contact with the electrical terminal.

In some aspects, the techniques described herein relate to a method, wherein the conductor is spaced apart from the electrical terminal when the voltage is applied across the first and second welding probes, wherein the exposed face of the conductor is moved into proximity with the contact face of the electrical terminal after the voltage is applied across the first and second welding probes, thereby creating an electrical arc between the exposed face of the conductor and the contact face of the electrical terminal, and wherein the exposed face of the conductor is moved into intimate mechanical contact with the contact face of the electrical terminal.

In some aspects, the techniques described herein relate to a method, wherein the electrical terminal is spaced apart from the conductor when the voltage is applied across the first and second welding probes and wherein the electrical terminal is bent to move the contact face of the electrical terminal into intimate mechanical and electrical contact with the exposed face of the conductor while the voltage is applied across the first and second welding probes.

In some aspects, the techniques described herein relate to a method, further including placing the electrical terminal within an electrically insulative housing, wherein the housing defines an access portal configured to allow the first welding probe to be in intimate mechanical and electrical contact with the conductor; and extending the first welding probe through the access portal such that it is in intimate mechanical and electrical contact with the conductor.

In some aspects, the techniques described herein relate to a method, further including placing the electrical terminal within an electrically insulative housing, wherein the housing defines an access portal configured to allow the second welding probe to be in intimate mechanical and electrical contact with the electrical terminal; and extending the second welding probe through the access portal such that it is in intimate mechanical and electrical contact with the electrical terminal.

In some aspects, the techniques described herein relate to a method, wherein the wire cable is a coaxial wire cable, wherein the conductor is a central conductor surrounded by an inner insulator and wherein the inner insulator is surrounded by a shield conductor, wherein the central conductor extends beyond the inner insulator.

In some aspects, the techniques described herein relate to a method, wherein the wire cable is a coaxial wire cable, wherein the conductor is a central conductor surrounded by an inner insulator and wherein the inner insulator is surrounded by a shield conductor, wherein the exposed face is flush with an end of the inner insulator.

In some aspects, the techniques described herein relate to a method, further including: displacing a portion of the inner insulator to expose a portion of the central conductor, wherein the portion of the inner insulator is spaced apart from the exposed face; folding the shield conductor back to expose the portion of the central conductor, thereby providing access for a welding probe to be in intimate mechanical and electrical contact with the central conductor; and placing a first welding probe in intimate mechanical and electrical contact with the exposed portion of the central conductor.

In some aspects, the techniques described herein relate to a method, further including folding the shield conductor over the exposed portion of the central conductor after applying the voltage across the first and second welding probes; and placing a ferrule over the shield conductor, thereby enclosing the exposed portion of the central conductor.

In some aspects, the techniques described herein relate to a method, further including: placing the electrical terminal within an electrically insulative housing, wherein the housing defines an access portal configured to allow the first or second welding probe to be in intimate mechanical and electrical contact with the central conductor or electrical terminal; placing the housing within an outer shielding, wherein the outer shielding terminal defines an access aperture that is arranged coaxially with the access portal of the housing, wherein the outer shielding terminal defines a tab located proximate the access aperture; and bending the tab over to enclose the access aperture and the access portal.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An electrical connector assembly, comprising:
a wire cable having an elongate conductor extending along a longitudinal axis, wherein the elongate conductor defines an exposed face arranged substantially perpendicular to the longitudinal axis and wherein the exposed face has a surface area that is substantially equal to a cross sectional area of the elongate conductor; and
an electrical terminal having a contact face metallurgically welded to the exposed face of the elongate conductor.

2. The electrical connector assembly according to claim 1, further comprising a housing formed of an electrically insulative material in which the electrical terminal is disposed, wherein the housing defines an access portal configured to allow a welding probe to be in intimate mechanical and electrical contact with the elongate conductor.

3. The electrical connector assembly according to claim 2, wherein the access portal is located and arranged in the housing such that the welding probe may be in intimate mechanical and electrical contact with the elongate conductor both when the exposed face is spaced apart from the contact face and when the exposed face is in intimate contact with the contact face.

4. The electrical connector assembly according to claim 2, further comprising an outer shielding terminal in which the housing is disposed, wherein the outer shielding terminal defines an access aperture that is arranged coaxially with the access portal of the housing.

5. The electrical connector assembly according to claim 4, wherein the outer shielding terminal defines a tab which is configured to be bent into the access aperture, thereby enclosing the access portal.

6. The electrical connector assembly according to claim 1, wherein the wire cable is a coaxial wire cable, wherein the elongate conductor is a central conductor of the coaxial wire cable and is surrounded by an inner insulator, wherein the inner insulator is surrounded by a shield conductor, and wherein the central conductor extends beyond the inner insulator.

7. The electrical connector assembly according to claim 1, wherein the wire cable is a coaxial wire cable, wherein the elongate conductor is a central conductor of the coaxial wire cable and is surrounded by an inner insulator, wherein the inner insulator is surrounded by a shield conductor, and wherein the exposed face of the central conductor is flush with an end of the inner insulator.

8. The electrical connector assembly according to claim 7, wherein a portion of the central conductor that is spaced apart from the exposed face is exposed due to removal of a portion of the inner insulator, thereby providing access for a welding probe to be in intimate mechanical and electrical contact with the central conductor.

9. A method of assembling an electrical connector, comprising:
providing a wire cable having an elongate conductor extending along a longitudinal axis, wherein the elongate conductor defines an exposed face arranged substantially perpendicular to the longitudinal axis and having a surface area substantially equal to a cross sectional area of the elongate conductor;
providing an electrical terminal having a contact face;
placing a first welding probe in intimate mechanical and electrical contact with the elongate conductor and placing a second welding probe in intimate mechanical and electrical contact with the electrical terminal;
placing the exposed face of the elongate conductor in intimate mechanical and electrical contact with the electrical terminal; and
applying electrical power as a voltage across the first and second welding probes, thereby forming a welded metallurgical bond between the elongate conductor and the electrical terminal.

10. The method according to claim 9, wherein the voltage is applied across the first and second welding probes after the exposed face of the elongate conductor is placed in intimate mechanical and electrical contact with the electrical terminal.

11. The method according to claim 9, wherein the voltage is applied across the first and second welding probes before the exposed face of the elongate conductor is placed in intimate mechanical and electrical contact with the electrical terminal.

12. The method according to claim 11, wherein the elongate conductor is spaced apart from the electrical terminal when the voltage is applied across the first and second welding probes, wherein the exposed face of the elongate conductor is moved into proximity with the contact face of the electrical terminal after the voltage is applied across the first and second welding probes, thereby creating an electrical arc between the exposed face of the elongate conductor and the contact face of the electrical terminal, and wherein the exposed face of the elongate conductor is moved into intimate mechanical contact with the contact face of the electrical terminal.

13. The method according to claim 9, wherein the electrical terminal is spaced apart from the elongate conductor when the voltage is applied across the first and second welding probes and wherein the electrical terminal is bent to move the contact face of the electrical terminal into intimate mechanical and electrical contact with the exposed face of the elongate conductor while the voltage is applied across the first and second welding probes.

14. The method according to claim 9, further comprising:
placing the electrical terminal within a housing formed of an electrically insulative material, wherein the housing defines an access portal configured to allow the first welding probe to be in intimate mechanical and electrical contact with the elongate conductor; and
extending the first welding probe through the access portal such that it is in intimate mechanical and electrical contact with the elongate conductor.

15. The method according to claim 9, further comprising:
placing the electrical terminal within a housing formed of an electrically insulative material, wherein the housing defines an access portal configured to allow the second welding probe to be in intimate mechanical and electrical contact with the electrical terminal; and
extending the second welding probe through the access portal such that it is in intimate mechanical and electrical contact with the electrical terminal.

16. The method according to claim 9, wherein the wire cable is a coaxial wire cable, wherein the elongate conductor is a central conductor surrounded by an inner insulator and wherein the inner insulator is surrounded by a shield conductor, wherein the central conductor extends beyond the inner insulator.

17. The method according to claim 9, wherein the wire cable is a coaxial wire cable, wherein the elongate conductor is a central conductor surrounded by an inner insulator and wherein the inner insulator is surrounded by a shield conductor, wherein the exposed face is flush with an end of the inner insulator.

18. The method according to claim 17, further comprising:
displacing a portion of the inner insulator to expose a portion of the central conductor, wherein the portion of the inner insulator is spaced apart from the exposed face;
folding the shield conductor back to expose the portion of the central conductor, thereby providing access for a welding probe to be in intimate mechanical and electrical contact with the central conductor; and
placing a first welding probe in intimate mechanical and electrical contact with an exposed portion of the central conductor.

19. The method according to claim 18, further comprising:
folding the shield conductor over the exposed portion of the central conductor after applying the voltage across the first and second welding probes; and
placing a ferrule over the shield conductor, thereby enclosing the exposed portion of the central conductor.

20. The method according to claim 9, further comprising:
placing the electrical terminal within a housing formed of an electrically insulative material, wherein the housing defines an access portal configured to allow the first or second welding probe to be in intimate mechanical and electrical contact with the elongate conductor or electrical terminal;
placing the housing within an outer shielding terminal, wherein the outer shielding terminal defines an access aperture that is arranged coaxially with the access portal of the housing, wherein the outer shielding terminal defines a tab located proximate the access aperture; and
bending the tab to enclose the access aperture and the access portal.
